(19) United States
(12) Patent Application Publication
(10) Pub. No.: US 2011/0181491 A1
(43) Pub. Date: Jul. 28, 2011

(54) ELECTRONIC DEVICE WITH DOUBLE DISPLAY SCREENS

(75) Inventor: SONG-LING YANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/912,757

(22) Filed: Oct. 27, 2010

(30) Foreign Application Priority Data
Jan. 27, 2010 (CN) 201010300832.7

(51) Int. Cl. G09G 5/00

(52) U.S. Cl. 345/1.1

(57) ABSTRACT

A method of an electronic device for controlling text information displayed on a second display unit to be outside an area occupied by a first display unit is provided. Supplying the second display unit installed above top surface of the first display unit and capable of moving on the top surface of the first display unit, the size of the second display unit is less than that of the first display unit, a coil is set below bottom surface of the second display unit, and a coil unit is set below the first display unit. Determining a relative position of the coil to the coil unit. Determining a covered area occupied by the second display unit on a first display unit; and controlling text information displayed on the first display area to be outside the covered area. An electronic device with double display screens is also provided.

### BACKGROUND

1. Technical Field

The present disclosure relates to electronic devices with double display screens and, particularly, to an electronic device and a control method allowing two display screens to work simultaneously.

2. Description of Related Art

It is well known that many mobile phones have double display screens. The two display screens of the mobile phones generally respectively display distinct information, for example, a small display screen is generally used to display clock and status information, and a big display screen is generally used to provide an interface to communicate with a user. However, if the user wants to see the contents on both the display screens simultaneously, it cannot be achieved.

Therefore, it is necessary to provide an electronic device and a control method that can resolve the above problem.

### BRIEF DESCRIPTION OF THE DRAWINGS

Many aspects of the present disclosure should be better understood with reference to the following drawings. The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an exploded, schematic view showing an electronic device with double display screens.

FIG. 2 is a block diagram showing the electronic device of FIG. 1.

FIG. 3 is a schematic diagram showing text information displayed on a first display unit being outside an area occupied by a second display unit, the size of the second display unit is less than that of the first display unit, according to one exemplary embodiment.

FIG. 4 is a flowchart of implementing a method of controlling text information displayed on the second display unit to be outside the area occupied by a first display unit, according to one exemplary embodiment.

### DETAILED DESCRIPTION

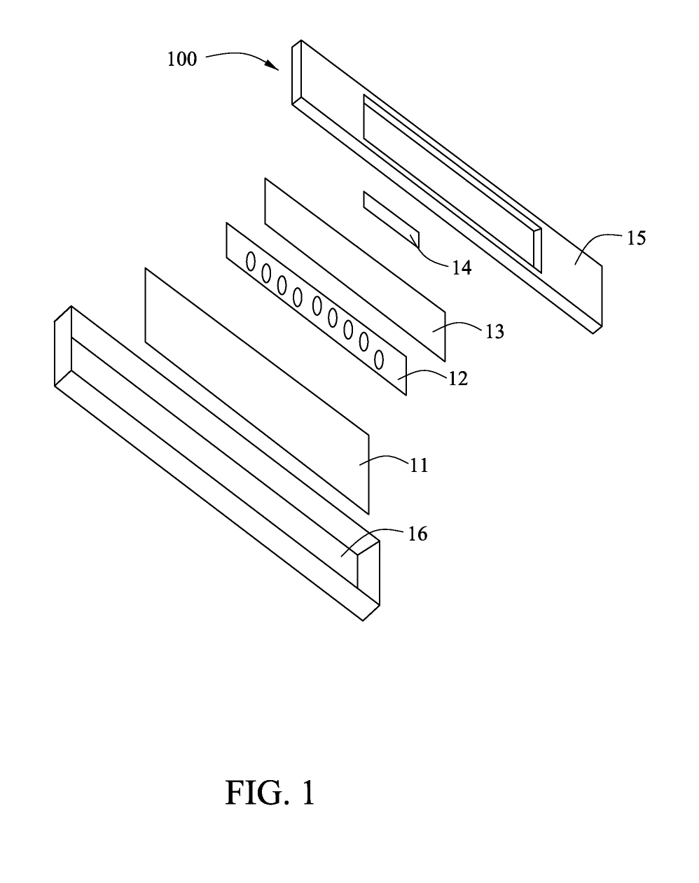

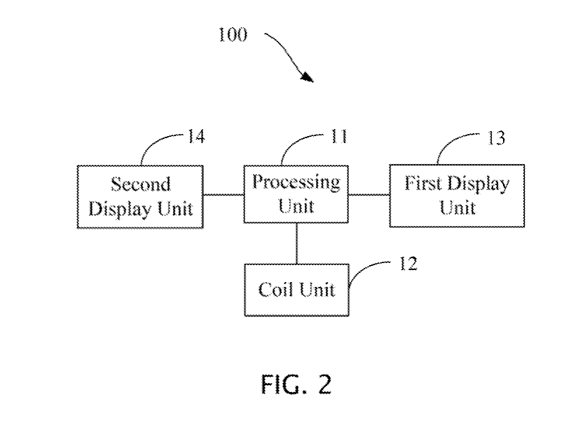

Referring to FIGS. 1-2, an electronic device 100 includes a processing unit 11, a coil unit 12, a first display unit 13, a second display unit 14, a frame 15, and a back cover 16. The processing unit 11 is electronically connected with the coil unit 12, the first display unit 13, and the second display unit 14. The coil unit 12, the first display unit 13, and the second display unit 14 obtain power from a power supply (not shown). The first display unit 13, the second display unit 14, the processing unit 11, and the coil unit 12 are assembled in space formed between the frame 15 and the back cover 16.

The first display unit 13 is set above the coil unit 12, and connects with the processing unit 11 using conventional technology. The second display unit 14 is set above the top surface of the first display unit 13, the size of the second display unit 14 is less than that of the first display unit 13. The second display unit 14 could move on the top surface of the first display unit 13 using conventional technology, and obtain data from the processing unit 11. In an embodiment, the second display unit 14 can obtain data from the processing unit 11 through transparent transmission lines.

The coil unit 12 is set below the first display unit 13. A number of coils are set on the coil unit 12 and work after obtaining the power. The second display unit 14 has a coil, which is set on the center of the bottom surface thereof. When the second display unit 14 moves on the top surface of the first display unit 13, the coil couples with the coil unit 12, energy transmits between the coil and the coil unit 12.

A relative position of the coil to the coil unit 12 can be determined according to the energy transmitting using conventional technology. The coil is set on the center of the bottom surface of the second display unit 14. The shape and size of the first display unit 13 and the second display unit 14 are predetermined. A covered area occupied by the second display unit 14 on the first display unit 13 can be determined according to predetermined shape and size of the first display unit and the second display unit and the relative position of the coil to the coil unit. The processing unit 11 determines the covered area and controls text information displayed on the first display area 13 to be outside the covered area.

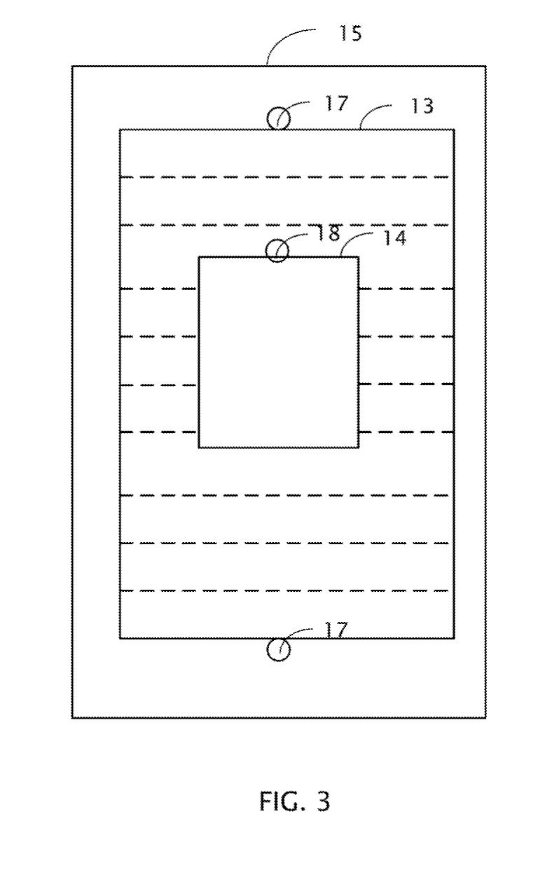

As shown in FIG. 3, the first display area 13 and the second display area 14 display distinct information. For example, the first display unit 13 displays text information, and the second display unit 14 displays video information. Further, the first display unit 13 displays the text information from the covered area occupied by the second display unit 14.

In another embodiment, the electronic device 100 further includes at least one infrared emitting device 17 installed on the frame 15 for transmitting data from the processing unit 11, and an infrared receiving device 18 installed on the second display unit 14 for receiving data from the infrared emitting device 17 to display the data on the second display unit 14. As one infrared emitting device 17 only functions in a predetermined area on the first display area 13, different infrared emitting devices 17 are installed at different positions of the frame 15. Each of the infrared emitting devices 17 respectively function in a corresponding area. When the second display unit 14 moves from one area to another area, the infrared emitting device 17 automatically switches to function and transmits the data to infrared receiving device 18 on the second display unit 14.

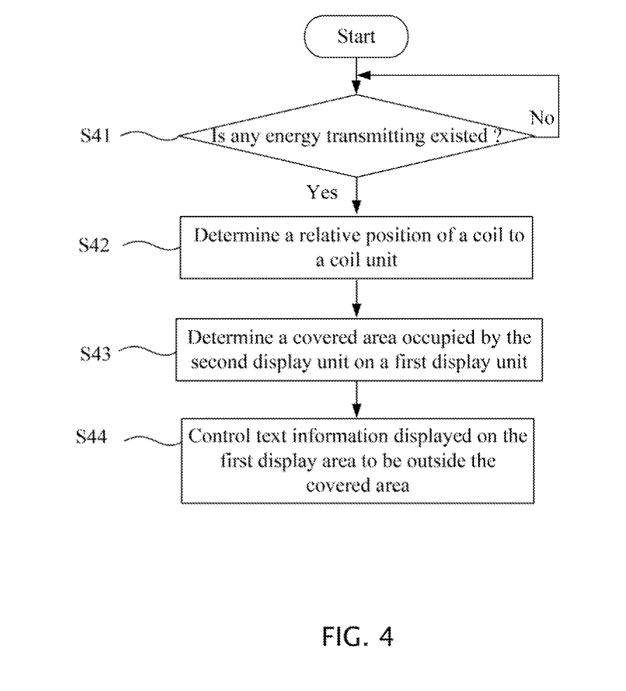

FIG. 4 is a flowchart of implementing a method of controlling the electronic device 100 of FIG. 1. The processing unit 11 implements the following steps: in step S41, determining if any energy transmitting is existed between the coil unit 12 and the coil setting on the second display unit 14. If yes, the procedure goes to step S42, otherwise, the procedure goes to S41. In step S42, determining the relative position of the coil to the coil unit 12, and the procedure goes to S43. In step S43, determining the covered area occupied by the second display unit 14 on the first display unit 13, and the procedure goes to S44. In step S44, controlling the text information displayed on the first display area 13 to be outside the covered area.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. An electronic device with double display screens, comprising:
a first display unit;
a second display unit installed above top surface of the first display unit, and capable of moving on the top surface of the first display unit, wherein size of the second display unit is less than that of the first display unit, a coil is set below bottom surface of the second display unit;
a coil unit set below the first display unit, coupled with the coil to generate energy transmitting; and
a processing unit electronically connected with the first display unit, the second display unit, and the coil unit,
wherein the processing unit determines a relative position of the coil to the coil unit, further determines a covered area occupied by the second display unit, and controls text information displayed on the first display area to be outside the covered area.

2. The electronic device according to claim 1, wherein the first display unit and the second display unit display distinct information.

3. The electronic device according to claim 2, wherein the first display unit displays text information, and the second display unit displays video information.

4. The electronic device according to claim 1, wherein the covered area occupied by the second display unit is determined according to predetermined shapes and sizes of the first display unit and the second display unit, and the relative position of the coil to the coil unit.

5. The electronic device according to claim 1, wherein the electronic device further comprises a frame and a back cover, the first display unit, the processing unit, the coil unit and the second display unit are assembled in space formed between the frame and the back cover.

6. The electronic device according to claim 1, wherein the second display unit obtain data from the processing unit through transparent transmission lines.

7. The electronic device according to claim 1, wherein the electronic device further comprises at least one infrared emitting device for transmitting data from the processing unit, and an infrared receiving device installed on the second display unit for receiving data from the infrared emitting device.

8. The electronic device according to claim 1, wherein the electronic device further comprises a plurality of infrared emitting devices installed at different positions of the frame, each of the infrared emitting devices functions in a corresponding area, respectively.

9. The electronic device according to claim 8, wherein when the second display unit moves from one area to another area, the plurality of infrared emitting device automatically switches to function and transmits the data to infrared receiving device on the second display unit.

10. The electronic device according to claim 8, wherein the coil unit includes a plurality of coils.

11. A method of an electronic device with double display screens for controlling text information displayed on a second display unit to be outside an area occupied by a first display unit, comprising:
supplying the first display unit, the second display unit and a coil unit, wherein the second display unit is installed above top surface of the first display unit, and capable of moving on the top surface of the first display unit, size of the second display unit is less than that of the first display unit, a coil is set below bottom surface of the second display unit, the coil unit is set below the first display unit;
determining if any energy transmitting is existed between a coil unit and the coil;
determining a relative position of the coil to the coil unit;
determining a covered area occupied by the second display unit on the first display unit; and
controlling text information displayed on the first display area to be outside the covered area.

12. The method according to claim 11, wherein the first display unit and the second display unit display distinct information.

13. The method according to claim 12, wherein the first display unit displays text information, and the second display unit displays video information.

14. The method according to claim 11, wherein the covered area occupied by the second display unit is determined according to predetermined shapes and sizes of the first display unit and the second display unit, and the relative position of the coil to the coil unit.
